(19) United States
(12) Patent Application Publication
(10) Pub. No.: US 2005/0167638 A1
(43) Pub. Date: Aug. 4, 2005

(54) Antioxidant composition for organic materials

(75) Inventors: Fumitoshi Kojima, Nishinomiya-shi (JP); Toshiya Takahashi, Kawanishi-shi (JP)

Correspondence Address: FOLEY AND LARDNER;SUITE 500, 3000 K STREET NW, WASHINGTON, DC, 20007, US

(73) Assignee: SUMITOMO CHEMICAL COMPANY, LIMITED

(21) Appl. No.: 11/045,582

(22) Filed: Jan. 31, 2005

(30) Foreign Application Priority Data
Feb. 3, 2004 (JP) 2004-026443

(51) Int. Cl. C09K 15/22

(52) U.S. Cl. 252/403

(57) ABSTRACT

There are disclosed An antioxidant composition for organic material, which comprises, as effective ingredients,
a) a hindered phenol compound of formula (I): 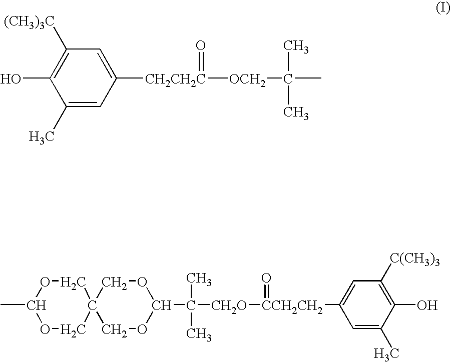 b) at least one metal compound, wherein the metal is selected from the group consisting of Groups I, II and IV of the Periodic Table of Element according to IUPAC Recommendations 1985, and wherein the weight ratio of the ingredient b) in terms of the metal to the total amount of ingredients a) and b) is 1 ppm or more, and an organic material composition containing the antioxidant composition.

### FIELD OF THE INVENTION

The present invention relates to antioxidant composition for organic materials and organic material composition containing the same.

### BACKGROUND OF THE INENTION

An organic material such as polyolefin or polyurethane is employed in various fields and it is usually processed after addition of antioxidant thereto because of softening and embrittlement through the action of heat or oxygen during processing. However, the processed organic material as above had a problem in that the appearance thereof is deteriorated through yellowing caused by the action of nitrogen oxide (NOx gas) or sunlight.

The polyolefin resin composition containing the hindered phenol compound of formula (I) shown below is known to prevent yellowing (JP8-2998B, claims and Table 1 are referred to).

There is a known sheet produced by the steps of reacting polytetramethylene glycol with 4,4′-diphenylmethanediisocyanate to obtain a solution of intermediate polymer in dimethylformamide, and adding the solution to a solution of triethylenediamine in dimethylformamide to produce polyurethane, and mixing the polyurethane solution with the hindered phenol compound of formula (I), and then coating the resulting solution of the compound of formula (I) on a polyester film (JP6-35538B).

However, anti-yellowing effect found in the polyolefin resin composition and the sheet is not always satisfactory.

### DETAILED DESCRIPTION OF THE INVENTION

According to the present invention, yellowing of organic materials can be effectively prevented.

One aspect of the invention relates to an antioxidant composition for organic material, which comprises, as effective ingredients,
a) a hindered phenol compound of formula (I): 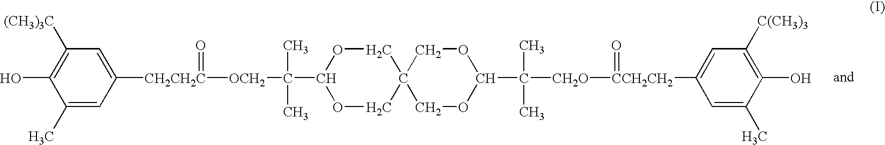
b) at least one metal compound, wherein the metal is selected from the group consisting of Groups I, II and IV of the Periodic Table of Element according to IUPAC Recommendations 1985, and
wherein the weight ratio of the ingredient b) in terms of the metal to the total amount of ingredients a) and b) is 1 ppm or more, hereinafter referred to as the “antioxidant composition (A)” in the present specification.

Another aspect of the invention relates to an organic material composition comprising
the composition (A) above and
c) an organic material, and
wherein the weight ratio of a) the hindered phenol compound of formula (I) above to c) the organic material is in a range of 100 ppm to 10000 ppm, herein after referred to as the “organic material composition (B)” in the present specification.

Examples of the metal of Group I of the Periodic Table of Element include Li, Na and K, and preferred is Li or Na.

Examples of the metal of Group II of the Periodic Table of Element include Mg, Ca and the like, and preferred is Ca.

Examples of the metal of Group IV of the Periodic Table of Element include Ti, Zr and Hf, and preferred is Ti.

Examples of the metal compound b) in the antioxidant composition (A) include, for example, an inorganic metal compound containing the metal or metals above and an atom or atoms selected from the group consisting of carbon, oxygen, sulfur, hydrogen and halogen.

Specific examples thereof include, for example,
metal compounds of Group I of the Periodic Table of Element such as lithium hydroxide, sodium hydroxide, potassium hydroxide, sodium sulfate, potassium sulfate, lithium sulfate or the like.
metal compounds of Group II of the Periodic Table of Element such as calcium oxide, calcium carbonate, magnesium carbonate, magnesium sulfate, magnesium oxide, calcium hydroxide, magnesium hydroxide or the like.
metal compounds of Group III of the Periodic Table of Element such as titanium oxide, titanium tetrachloride, hafnium oxide, zirconia or the like.

The metal compounds above also include hydrate thereof.

When the antioxidant composition (A) is applied for polyolefin as the organic material preferred ratio of the at lest one metal compound b) in terms of the metal to the total amount of the at least one metal compound b) and the hindered phenol compound a) is 30 ppm or less, more preferably it is 20 ppm or less, yet more preferably it is 15 ppm or less.

The ratio of the at least one metal compound b) in terms of the metal to the total amount of the hindered phenol compound a) and the at least one metal compound b) is preferably at 30 ppm or less since the coloring of the hindered phenol compound a) is controlled.

When the antioxidant composition (A) is applied for polyurethane as the organic material preferred ratio of the at lest one metal compound b) in terms of the metal to the total amount of the at least one metal compound b) and the hindered phenol compound a) is 15 ppm or less since the polymerization reaction proceeds well when mixed in such a ratio to the intermediate polymer of polyurethane.

The hindered phenol compounds (I) can be produced, for example, by a process described in JP7-278154A (e.g. Example 1).

The antioxidant composition (A) of the present invention can be prepared by mixing the hindered phenol compound (I) and the metal compound above, for example, by a dry blending method using a kneading machine such as Henshel mixer, V-blender or the like.

It can also be prepared, for example, by the steps of mixing a solution of the hindered phenol compound (I) in a hydrophobic organic solvent, which was prepared by dissolving an ester exchange reaction mixture obtained by a process disclosed in JP7-278154A in a hydrophobic organic solvent and a suitable amount of the metal compound, and crystallizing.

The antioxidant composition (A) is suitably used for an organic material (B), which is typically resins such as polyolefin or polyurethane, and the followings are examples of the organic material including polyolefin and polyurethane resins.
(1) Polyethylene (high density polyethylene, low density polyethylene, linear low-density polyethylene)
(2) Polypropylene (random or block copolymer of propylene/ethylene)
(3) Methyl pentene type organic material
(4) Cyclic polyolefin
(5) EEA (ethylene/ethyl acrylate copolymerization) resin
(6) Ethylene/vinyl acetate copolymerization resin,
(7) Polystyrene [polystyrene, poly (p-methylstyrene), poly(a-methylstyrene)]
(8) AS (acrylonitrile/styrene copolymerization) resin
(9) ABS (acrylonitrile/butadiene/styrene copolymerization) resin
(10) AAS (special acrylic elastomer/acrylonitrile/styrene copolymerization) resin
(11) ACS (acrylonitrile/chlorinated polyethylene/styrene copolymerization) resin
(12) Chlorinated polyethylene, polychloroprene and chloridization gum
(13) Polyvinylchloride and polyvinylidene chloride
(14) Methacrylic resin
(15) Ethylene/vinyl alcohol copolymerization resin
(16) Fluororesin
(17) Polyacetal
(18) Grafted polyphenylene ether resin and polyphenylene sulfide resin
(19) Polyurethane (including elastic yarn, and foam)
(20) Polyamide
(21) Polyester resin (polyethylene terephthalate, polybutylene terephthalate),
(22) Polycarbonate
(23) Polyacrylate
(24) Polysulfone, polyetheretherketone and polyethersulfone
(25) Thermoplastic resin such as aromatic polyester resin,
(26) Epoxide resin
(27) Diallyphthalate prepolymer
(28) Silicone resin
(29) Unsaturated polyester resin
(30) Acrylic modification benzoguanamine resin
(31) Benzoguanamine/melamine resin
(32) Thermosetting resin such as urea resin,
(33) Polybutadiene
(34) 1,2-Polybutadiene
(35) Polyisoprene,
(36) Styrene/butadiene copolymer
(37) Butadiene/acrylonitrile copolymer
(38) Ethylene/propylene copolymer
(39) Silicone rubber
(40) Epichlorohydrin gum
(41) Acrylic elastomer
(42) Natural rubber.
(43) Chlorine-rubber type paint
(44) Polyester resin paint
(45) Urethane resin paint,
(46) Epoxy resin coating
(47) Acrylic coating
(48) Vinyl resin paint
(49) Amino-alkyd resin paint,
(50) Alkyd resin coating
(51) Nitrocellulose resin coating
(52) Oil paint
(53) Wax
(54) Lubricating oil

The antioxidant composition for organic materials of present invention (A) is employed for each organic material or mixtures of them, and is preferably used for polyolefin or polyurethane, particularly preferably for polypropylene and polyurethane elastomers.

The organic materials or mixtures thereof possess superior physical, chemical and electrical properties, and are processed into pipes, sheets, films or fibers by various methods such as blow forming, extrusion, injection molding, calendaring or the like.

The antioxidant composition (A) of the invention is usually mixed with the organic materials c) by processes or by using apparatus as usually employed for mixing organic materials and stabilizers, coloring materials or fillers.

The antioxidant composition (A) of the invention can be added to the organic material, for example, in the production process of the organic material by dissolving in the polymerization solvent used for producing the organic material or after termination of the polymerization or by heat-melted.

The antioxidant composition (A) may also be mixed with the organic material in a melt-kneading process directly by dry-blending method optionally as a mixture with other additives.

It may be heat-melt optionally with other additives and added to the organic material. Alternatively, it may be dissolved or suspended in a liquid medium optionally with other additives and added to the organic material.

Other additives as listed below may be used simultaneously with the antioxidant composition of the present invention when preparing the organic material composition of the present invention (B) as long as they do not adversely affect the anti-yellowing activity of the antioxidant composition of the invention.

Typical examples of such additives include, for example, phenol type antioxidants, sulfur type antioxidants, phosphorus type antioxidants, UV absorbers, light stabilizers, peroxide scavengers, polyamide stabilizers, hydroxylamines, lubricants, plasticizers, fire retardants, nucleating agents, metal deactivators (e.g. chelating agents), antistatic agents, pigments, fillers, pigments, anti-blocking agents, surface active agents, processing aids, blister agents, emulsifying agents, brighteners, neutralizers, coloration modifiers such as 9,10-dihydro-9-oxa-10-phosphophenanthrene-10-oxide, and auxiliary stabilizers such as benzofurans or indolines as disclosed in U.S. Pat. Nos. 4,325,853, 4,338,244, 5,175,312, 5,216,053, 5,252,643, and 4,316,611, DE-A-4316622 and 4316876, EP-A-589839 and 591102.

Alternatively, the additives may be mixed with the organic material at a suitable step to prepare the anti-yellowing organic material composition, or they may be mixed independently from the antioxidant composition of the present invention.

Examples of the sulfur type antioxidant include, for example, dilauryl 3,3′-thiodipropionate, Tridecyl 3,3′-thiodipropionate, dimyristyl 3,3-thiodipropionate, distearyl 3,3′-thiodipropionate, lauryl stearyl 3,3′-thiodipropionate, and neopentanetetrayl tetrakis(3-laurylthiopropionate).

Examples of the phosphorous type antioxidant include, for example, triphenyl phosphite, tris(nonylphenyl)phosphite, tris(2,4-di-t-butylphenyl) phosphite, trilauryl phosphite, trioctadecyl phosphite, distearyl pentaerythritol diphosphite, diisodecyl pentaerythritol diphosphite, bis(2,4-di-t-butylphenyl) pentaerythritol diphosphite, bis(2,4-di-t-butyl-6-methylphenyl) pentaerythritol diphosphite, bis(2,6-di-t-butyl-4-methylphenyl) pentaerythritol diphosphite, bis(2,4,6-tri-t-butylphenyl) pentaerythritol diphosphite, tristearyl sorbitol triphosphite, tetrakis(2,4-di-t-butylphenyl)-4,4′-diphenylene diphosphonite, 2,2′-methylenebis(4,6-di-t-butylphenyl)-ethylhexyl phosphite, 2,2′-ethylidenebis(4,6-di-t-butylphenyl)fluoro phosphite, bis(2,4-di-t-butyl-6-methylphenyl)ethyl phosphite, bis(2,4-di-t-butyl-6-methylphenyl)methyl phosphite, bis(2,4,6-tri-t-butylphenyl)-5-ethyl-5-butyl-1,3,2-oxa-phosphorinane, 2,2′,2″-nitrylo[triethyl-tris(3,3′,5,5′-tetra-t-butyl-1,1′-biphenyl-2,2′-diyl)phosphite and mixtures of these compounds.

Examples of the benzofuranone type stabilizers include, for example, 5,7-di-t-butyl-3-(3,4-dimethylphenyl)₃H-benzofuran-2-on and the like.

Examples of the UV absorbers include, for example following compounds.

(1) Examples of salicylate compounds: phenyl salicylate, 4-t-butylphenyl salicylate, 2,4-di-t-butylphenyl 3′,5′-di-t-butyl-4′-hydroxybenzoate, 4-t-octylphenyl salicylate, bis(4-t-butylbenzoyl) resorcinol, benzoylresorcinol, hexadecyl 3′,5′-di-t-butyl-4′-hydroxybenzoate, octadecyl 3′,5′-di-t-butyl-4′-hydroxybenzoate, 2-methyl-4,6-di-t-butylphenyl 3′,5′-di-t-butyl-4′-hydroxybenzoate and mixture thereof.

(2) Examples of 2-dihydroxybenzophenone compound: 2,4-dihydroxybenzophenone, 2-hydroxy-4-methoxybenzophenone, 2-hydroxy-4-octyloxybenzophenone, 2,2′-dihydroxy-4-methoxybenzophenone, bis(5-benzoyl-4-hydroxy-2-methoxyphenyl)methane, 2,2′,4,4′-tetrahydroxybenzophenone and mixtures thereof.

(3) Examples of 2-(2′-hydroxyphenyl)benzotriazole: 2-(2-hydroxy-5-methylphenyl)benzotriazole, 2-(3′,5′)-Di-t-butyl-2′-hydroxyphenyl)benzotriazole, 2-(5′-t-butyl-2′-hydroxyphenyl)benzotriazole, 2-(2′-hydroxy-5′-t-octylphenyl)benzotriazole, 2-(3-t-butyl-2-hydroxy-5-methylphenyl)-5-chlorobenzotriazole, 2-(3′-s-butyl-2′-hydroxy-5′-t-butylphenyl)benzotriazole, 2-(2′-hydroxy-4′-octyloxyphenyl)benzotriazole, 2-(3′,5′-di-t-amyl-2′-hydroxyphenyl)benzotriazole, 2-[2′-hydroxy-3′,5′-bis(α, α-dimethylbenzyl)phenyl]-2H-benzotriazole, 2-[3′-t-butyl-2′-hydroxyphenyl)-5′-(2-octyloxycarbonylethyl)phenyl]-5-chlorobenzotriazole, 2-[2-(2-ethylhexyloxy)]-5-[3′-t-butyl-5′-carbonylethyl]-2′-hydroxyphenylchlorobenzotriazole, 2-[3′-t-butyl-2′-hydroxy-5′-(2-methoxycarbonylethyl)phenyl]-chlorobenzotriazole, 2-[3′-t-butyl-2′-hydroxy-5′-(methoxycarbonylethyl)phenyl]-benzotriazole, 2-[3′-t-butyl-2′-hydroxy-5-(2-octyloxycarbonylethyl)phenyl]-benzotriazole, 2-[3′-t-butyl-2′-hydroxy-5′-[2-(2-ethylhexyoxy)carbonyl-ethyl]phenyl]benzotriazole, 2-[2-hydroxy-3-(3,4,5,6-tetrahydrophthalimidemethyl)-5-methyl-phenyl]benzotriazole, 2-(3,5-di-t-butyl-2-hydroxyphenyl)-5-chlorobenzotriazole, Mixture of 2-(3′-dodecyl-2′-hydroxy-5′-methylphenyl)benzotriazole and 2-[3′-t-butyl-2′-hydroxy-5′-(2-isooctyloxycarbonylethyl) phenyl]benzotriazole, 2,2′-methylenebis[6-(2H-benzotriazol-2-yl)-4-(1,1,3,3)-tetramethylbutyl]phenol, 2,2′-methylenebis[4-t-butyl-6-(2H-benzotriazol-2-yl)phenol], condensate of poly(3-11)(ethylene glycol) and 2-[3′-t-butyl-2′-hydroxy-5′-(2-methoxycarbonylethyl)-phenyl]benzotriazole, condensate of poly(3-11) (ethylene glycol) and methyl 3[3-(2H-benzotriazol-2-yl)-5-t-butyl-4-hydroxyphenyl]propionate, 2-ethylhexyl 3-[3-t-butyl-5-(5-chloro-2H-benzotriazol-2-yl)-4-hydroxyphenyl]propionate, octyl 3-[3-t-butyl-5-(5-chloro-2H-benzotriazol-2-yl)-4-hydroxyphenyl]propionate, methyl 3-[3-t-butyl-5-(5-chloro-2H-benzotriazol-2-yl)-4-hydroxyphenyl]propionate, 3-[3-t-butyl-5-(5-chloro-2H-benzotriazol-2-yl)-4-hydroxy-phenyl]propionic acid and mixtures thereof.

Examples of the light stabilizers include, for example, following compounds.

(1) Amine type light stabilizers: bis(2,2,6,6-tetramethyl-4-piperidyl) sebacate, bis(2,2,6,6-tetramethyl-4-piperidyl) succinate, bis(1,2,2,6,6)-Pentamethyl-4-piperidyl) sebacate, bis(2,2,6,6-N-octyloxy-tetramethyl-4-piperidyl) sebacate, bis(2,2,6,6-N-benzylox-tetramethyl-4-piperidyl) sebacate, bis(2,2,6,6-N-cyclohexyloxy-tetramethyl-4-piperidyl) sebacate, bis(1,2,2,6,6-pentamethyl-4-piperidyl) 2-(3,5-di-t-butyl-4-hydroxybenzyl)-2-butyl malonate, bis(1-acroyl-2,2,6,6-tetramethyl-4-piperidyl), 2,2-bis(3,5-di-t-butyl-4-hydroxybenzyl)-2-butyl malonate, bis(1,2,2,6,6-pentamethyl-4-hydroxypiperidyl decandioate, 2,2,6,6-tetramethyl-4-piperidyl methacrylate, 4-[3-(3,5-di-t-butyl-4-hydroxyphenyl)propionyloxy]-1-[2-(3-(3,5-di-t-butyl-4-hydroxyphenyl)propionyloxy)ethyl]-2,2,6 ,6-tetramethyl-4-piperidylamino-N-(2,2,6,6-tetramethyl-4-piperidyl)propionamide, tetrakis(2,2,6,6-tetramethyl-4-piperidyl) 1,2,3,4-butanetetracarboxylate, tetrakis(1,2,2,6,6-pentamethyl-4-piperidyl) 1,2,3,4-butane-tetracarboxylate, mixed ester of 1,2,3,4-butanetetracarboxylic acid and 1,2,2,6,6-pentamethyl-4-piperidinol and 1-tridecanol, Mixed ester of 1,2,3,4-butanetetracarboxylic acid and 2,2,6,6-tetramethyl-4-piperidinol and 1-tridecanol, mixed ester of 1,2,3,4-butanetetracarboxylic acid and 1,2,2,6,6-pentamethyl-4-piperidinol and 3,9-bis(2-hydroxy-1,1-dimethylethyl)-2,4,8,10-tetraoxa-spiro-[5.5]undecane, mixed ester of 1,2,3,4-butanetetracarboxylic acid and 2,2,6,6 tetramethyl-4-piperidinol and 3,9-bis(2-hydroxy-1,1-dimethylethyl)-2,4,8,10-tetraoxaspiro[5.5]-undecane, polycondensate of dimethyl succinate and 1-(2-hydroxyethyl)-4-hydroxy-2,2,6,6-tetramethylpiperidine poly[(6-morpholino-1,3,5-triazine-2,4-diyl) ((2,2,6,6-(tetramethyl-4-piperidyl)imino)hexamethylene-((2,2,6,6-(tetramethyl-4-piperidyl)imino)], poly[(6-(1,1,3,3-tetramethylbutyl)imino-1,3,5-triazine-2,4-diyl((2,2,6,6-tetramethyl-4-piperidyl)imino)hexamethylene ((2,2,6,6-tetramethyl-4-piperidyl)imino)], polycondensate of N,N′-bis (2,2,6,6-tetramethyl-4-piperidyl)-hexamethylenediamine and 1,2-dibromoethane, N,N′-4,7-tetrakis[4,6-bis(N-butyl-N-(2,2,6,6-tetramethyl-4-piperidyl)amino)-1,3,5-triazine-2-yl]-4,7-diazadecane-1, 10-diamine, N,N′-4,7-tetrakis[4,6-bis(N-butyl-N-(1,2,6,6,6-pentamethyl -4-piperidyl)amino)-1,3,5-triazine-2-yl]-4,7-diazadecane-1,10-diamine, N,N′-4-tris[[4,6-bis(N-butyl-N-(1,2,2,6,6-pentamethyl-4-piperidyl)amino)]-1,3,5-triazine-2-yl]-4,7-diazadecane-1, 10-diamine and mixtures thereof.

(2) Examples of acrylate type light stabilizers: Ethyl α-cyano-β, β-diphenylacrylate, isooctyl α-cyano-β,β-diphenylacrylate, methyl α-carbomethoxycinamate, methyl α-cyano-β-methyl-p-methoxycinnamate, butyl α-cyano-β-methyl-p-methoxycinnamate, methyl α-carbomethoxy-p-methoxycinnamate, N-(β-carbomethoxy-β-cyanovinyl)-2-methylindoline and mixtures thereof.

(3) Examples of oxamide type light stabilizers: 4,4′-dioctyloxyoxanilide, 2,2′-diethoxyoxanilide, 2,2′-dioctyloxy-5,5′-di-t-butylanilide, 2,2′-didodecyloxy-5,5′-di-t-butylanilide, 2-ethoxy-2′-ethyloxanilide, N,N′-bis(3-dimethylaminopropyl)oxamide, 2-ethoxy-5-t-butyl-2′-ethoxyanilide, 2-ethoxy-5,4′-di-t-butyl-2′-ethyloxanilide and mixtures thereof.

(4) Examples of triazine-type light stabilizers: 2,4,6-tris(2-hydroxy-4-octyloxyphenyl)-1,3,5-triazine, 2-(2-hydroxyphenyl-4-octyloxyphenyl)-4,6-bis(2,4-dimethyl-phenyl)-1,3,5-triazine, 2-[2,4-dihydroxyphenyl-4,6-bis(2,4-dimethylphenyl)]-1,3,5-triazine, 2,4-bis(2-hydroxy-4-propyloxyphenyl)-6-(2,4-dimethylphenyl )-1,3,5-triazine, 2-(2-hydroxy-4-octyloxyphenyl)-4,6-bis(4-methylphenyl)-1,3 ,5-triazine, 2-(2-hydroxy-4-dodecyloxyphenyl)-4,6-bis-(2,4-dimethylphenyl)-1,3,5-Triazine, 2-[2-hydroxy-4-(2-hydroxy-3-butyloxypropoxy)phenyl]-4,6-bis (2,4-dimethylphenyl)-1,3,5-triazine, 2μ-hydroxy-4-(2-hydroxy-3-octyloxypropoxy)phenyl]bis(2,4-dimethylphenyl)-1,3,5-triazine and mixtures thereof.

Examples of hydroxylamine compounds: N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine and mixtures thereof.

### EXAMPLE

The present invention is illustrated by way of the following Examples but it is not to be construed to limit the invention thereto. The content ratio of the metal was conducted typically by ICP emission spectroscopy analysis of which detection limit of the metal is usually about 0.5 ppm.

Production of Powder A1

100 parts by weight of the hindered phenol compound (I) and 0.484 part by weight of lithium hydroxide monohydrate were kneaded by Wonder-blender to produce powders (A′1). 0.975 part by weight of the obtained powders (A′1) and 50 parts by weight of the hindered phenol compound (I) were kneaded by Wonder-blender to produce lithium hydroxide-containing powder (A1) as antioxidant for organic materials. Lithium content in (A1) by ICP emission spectroscopy analysis was found to be 11 ppm.

Production of Powder A2

Lithium hydroxide-containing antioxidant powder (A2) for organic materials was obtained by kneading 0.521 part by weight of the powder (A′1) obtained in Production 1 and 50 parts by weight of the hindered phenol compound (I) using Wonder-blender. Lithium content in (A1) by ICP emission spectroscopy analysis was found to be 3 ppm.

Production of Powder A3

Lithium hydroxide-containing antioxidant powders (A3) for organic materials was obtained by kneading 0.130 part by weight of the powder (A′1) obtained in Production 1 and 50 parts by weight of the hindered phenol compound (I) using Wonder-blender. Lithium content in (A1) by ICP emission spectroscopy analysis was found to be less than 0.5 ppm.

Production of Powder A4 to A9

Experiments were conducted in a similar manner as in the production of A1 except that the metal compounds listed in Table 1 below were used in place of lithium hydroxide monohydrate. Lithium contents of the powders A4 to A9 were analyzed by ICP emission spectroscopy.

TABLE 1

| Powders | A4 | A5 | A6 | A7 | A8 | A9 |
|---|---|---|---|---|---|---|
| Metal | Na₂SO₄ | CaO | CaO | CaO | TiO | TiO |
| Compound | | | | | | |
| Metal/ | Na | Ca | Ca | Ca | Ti | Ti |
| Ratio | 1.1 ppm | 15 ppm | 8 ppm | 2 ppm | 1.3 ppm | <0.5 ppm |

### Example 1

### Anti-Yellowing Test Using A1

Pellets of polypropylene resin composition was obtained by melt-kneading at 230° C. a mixture of 100 parts by weight of polypropylene and 0.1 part by weight of powder A1 prepared as above using a 30 mmØ mono-axis extruder. The obtained pellets were molded at 240° C. with an injection-molding apparatus to produce a sheet with 1 mm thickness, which was then exposed to 1950 ppm of NOx gas for two days. YI values of the sheet before and after the exposure were measured and the difference ΔYI was shown in Table 2 below. The smaller the ΔYI is, the more excellent the anti-yellowing effect is.

### Examples 2 to 7

In a similar manner as in Example 1, sheets containing the powder A2 or any one of A4 to A8 in place of B1 were prepared. ΔYI values were determined as shown in Table 2.

### Comparative Examples 1 to 3

Sheets containing powders A3 and A9 were prepared in a similar manner as in Example 1 except that powders A3 and A9 were used in place of A1. ΔYI values were shown in Table 3.

In Tables 2 and 3, “b*” means the weight of the metal compound in terms of the metal, “b” means the weight of the metal compound and “a” means the weight of the hindered phenol compound of formula (I).

TABLE 2

| Example | Powder | Metal | b*/(a + b) | ΔYI |
|---|---|---|---|---|
| 1 | A1 | Li | 11 ppm | 0.50 |
| 2 | A2 | Li | 3 ppm | 0.71 |
| 3 | A4 | Na | 1.1 ppm | 0.62 |
| 4 | A5 | Ca | 15 ppm | 0.75 |
| 5 | A6 | Ca | 8 ppm | 0.76 |
| 6 | A7 | Ca | 2 ppm | 0.77 |
| 7 | A8 | Ti | 1.3 ppm | 0.48 |

TABLE 3

| Comparative | | | | |
|---|---|---|---|---|
| Example | Powder | Metal | b*/(a + b) | ΔYI |
| 1 | None | None | 0 | 0.90 |
| 2 | A3 | Li | <0.5 ppm | 1.01 |
| 3 | A9 | Ti | <0.5 ppm | 0.94 |

1. An antioxidant composition for organic material, which comprises, as effective ingredients,
a) a hindered phenol compound of formula (I): 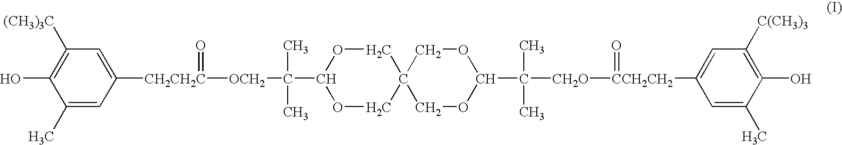
b) at least one metal compound, wherein the metal is selected from the group consisting of Groups I, II and IV of the Periodic Table of Element according to IUPAC Recommendations 1985, and wherein the weight ratio of the ingredient b) in terms of the metal to the total amount of ingredients a) and b) is 1 ppm or more.

2. An antioxidant composition according to claim 1, wherein the weight ratio of the ingredient b) in terms of the metal to the total amount of ingredients a) and b) is 30 ppm or less.

3. An antioxidant composition according to claim 1, wherein the weight ratio of the ingredient b) in terms of the metal to the total amount of ingredients a) and b) is 20 ppm or less.

4. An antioxidant composition according to claim 1, wherein the organic material is polyolefin.

5. An antioxidant composition according to claim 4, wherein the polyolefin is polypropylene.

6. An antioxidant composition according to claim 1, wherein the weight ratio of the ingredient b) in terms of the metal to the total amount of ingredients a) and b) is 15 ppm or less.

7. An antioxidant composition according to claim 1, wherein the organic material is polyurethane.

8. An antioxidant composition according to claim 1, wherein the metal is lithium or sodium.

9. An antioxidant composition according to claim 1, wherein the metal is calcium.

10. An antioxidant composition according to claim 1, wherein the metal is titanium.

11. An organic material composition comprising
the antioxidant composition as defined in claim 1 and
c) an organic material, and
wherein the weight ratio of a) the hindered phenol compound of formula (I) to c) the organic material is in a range of from 100 ppm to 10000 ppm.

12. A method for producing the organic material composition as defined in claim 11, which comprises compounding an antioxidant composition comprising
a) a hindered phenol compound of formula (I): 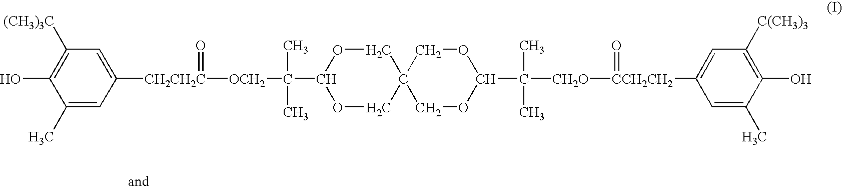
b) at least one metal compound, wherein the metal is selected from the group consisting of Groups I, II and IV of the Periodic Table of Element according to IUPAC Recommendations 1985, and wherein the weight ratio of the ingredient b) in terms of the metal to the total amount of ingredients a) and b) is 1 ppm or more, with c) an organic material, and
wherein the weight ratio of a) the hindered phenol compound of formula (I) to c) the organic material is in a range of from 100 ppm to 10000 ppm.
